(19) United States
(12) Patent Application Publication
(10) Pub. No.: US 2005/0214172 A1
(43) Pub. Date: Sep. 29, 2005

(54) Method and device for dosing small volumes of liquid

(76) Inventor: Ernst Burgisser, Rheinfelden (CH)

Correspondence Address: OPPEDAHL AND LARSON LLP, P O BOX 5068, DILLON, CO, 80435-5068, US

(21) Appl. No.: 10/515,933

(22) PCT Filed: May 12, 2003
(86) PCT No.: PCT/CH03/00300

§ 371 Date: Jan. 12, 2005

(30) Foreign Application Priority Data
May 24, 2002 (CH) 867/02

(51) Int. Cl. B01L 3/02

(52) U.S. Cl. 422/100

(57) ABSTRACT

The invention relates to a method for dosing a volume of liquid (VF) of less than 1 !l that is to be dispensed, by means of a dosing pump, in particular a pipette (2). According to said method, a tip (13) is completely filled with a liquid and contains the liquid (16) to be dispensed at least in the vicinity of its outlet (13a), a volume of gas (VL) is drawn into the tip (13) via the outlet (13a) and a volume corresponding to the sum of the volume of liquid (VF) to be dispensed and the volume of gas (VL) is then supplied to the tip (13) in such a way that the volume of liquid (VF) is dispensed via the outlet (13a) in a contactless manner. The device comprises a plurality of dosing pumps that can be simultaneously actuated, in particular pipettes (2), which can be actuated by an injection plunger (6), in addition to a motor (1), which drives the injection plungers (6) and also a valve (3), which is located between the dosing pump and its respective tip (13) in order to fill each system completely with liquid without any gas.

The invention relates to a method for metering small volumes of liquid, and to a device for metering small volumes of liquid.

### BACKGROUND

Increasing miniaturisation and parallelisation of biochemical, cellular-biological or molecular-biological test methods results in an increased need for devices being able to dispense in a contact-free and highly parallelized manner very small liquid volumes in the region of less than 1 μl. Droplets of a few microlitres cannot be dispensed in a contact-free manner by conventional pipettes, but need to be detached from the pipette by way of contacting a vessel surface or a liquid surface. This however involves the danger of an undesired contamination of the sample to be transferred.

For reproducible and exact pipetting of small liquid volumes it is known to use a device being filled with an incompressible liquid in an air-free manner, and comprising a pipette cylinder and a plunger displaceably mounted therein. Cylinder and plunger are designed for the exact metering of the liquid volume to be dispensed via positive displacement of the plunger. In order to be able to dispense liquid volumes of less than 1 μl in a contact-free manner using such devices, further auxiliary measures are necessary in order to overcome the adhesion forces which act between the liquid drop to be dispensed and the remaining liquid column.

In order to overcome the named adhesion forces, it is known to use so-called piezo-pipettes comprising a specially designed nozzle and a piezo-crystal which acts on the nozzle in a manner, such that the liquid drop is pressed out of the nozzle by way of a piezoelectric impulse. This impulse makes it possible to dispense very small liquid drops in a contact-free manner. The disadvantages of the piezo-pipette are its high cost and its not being suitable for highly-parallelized arrangements and, furthermore, its not permitting the use of disposable pipette tips.

The publication EP-0876219 discloses a further way for overcoming the named adhesion forces. The pipetting device according to this publication comprises an impulse generator which is arranged between the syringe (plunger, pipette cylinder) and the tip and which effects an impulse on the liquid column located in the pipetting device. One disadvantage of this pipetting device is the fact that it is little suitable for highly parallelized arrangements, because for safe, highly-parallelized dispensing, it would need a multitude of impulse generators which would render the pipetting device correspondingly expensive. A further disadvantage is the fact that an additional device is required for filling the pipette device in an air-free manner.

It is this desirable to create a method as well as a device for metering small liquid volumes of less than 1 μm, wherein method and device are to be inexpensive and, in particular, are to permit reliable dispensing of liquid volumes of even less than 100 nl.

### SUMMARY OF THE INVENTION

A method for metering and dispensing a volume of a size of less than 1 μl of a liquid to be dispensed is described, the method using a metering pump, in particular a pipette, wherein a tip is filled with a liquid and at least in the region of the tip's exit opening contains the liquid to be dispensed, wherein a gas volume is drawn into the tip via its exit opening, and wherein thereafter a volume corresponding to the sum of the liquid volume to be dispensed and the drawn-up gas volume is supplied to the tip in a manner such that the volume of liquid to be dispensed is dispensed via the exit opening in a contact-free manner.

The invention is based on the idea of using a syringe with motor-driven syringe plunger for metering very small volume units in the range for example between 10 nl and 1 μl, wherein firstly a gas or air volume is drawn into a liquid-filled tip, and then the syringe plunger is moved with a large acceleration in the opposite direction by a stroke, such that the displaced volume corresponds to the sum of the drawn-in air volume and the liquid volume to be dispensed. The liquid volume is such dispensed by being pressed out of the syringe or its tip respectively with an impact which is sufficient to overcome the adhesion forces acting on the liquid volume to be dispensed.

The method according to the invention makes it possible to meter and dispense very small volumes (lower limit of up to 10 nl) of a liquid to be dispensed in an accurate and reproducible manner, surprisingly even when using a syringe with a conventional, motor-driven syringe plunger. Therein, the volume which is dispensed from the tip or is displaced by the syringe plunger respectively consists of two part volumes, namely the drawn-up and then dispensed gas volume and the dispensed liquid volume. During dispensation of the gas volume the syringe plunger is able to be accelerated to a high plunger speed which is necessary for the liquid volume to be accelerated to a flow speed or exit speed respectively being required for overcoming the adhesion forces. An electric motor, preferably a commercially available, inexpensive electric motor is perfectly suitable as a motor-drive, although such motor has a certain intrinsic inertia which renders the effect of the method according to the invention non-obvious. The intrinsic inertia of the electric motor as well as its limited acceleration capability is of a minor significance in the method according to the invention since the motor-drive is accelerated during the discharges of the gas volume which is not critical with regard to time or speed. The inertia of the liquid filled syringe is also of a minor significance during the discharge of the gas volume. The stroke of the syringe plunger being required for discharging the gas volume, and the time needed for such discharge may be varied within a wide range by varying the size of the gas volume and/or by choosing a suitable diameter of the tip and/or of the syringe plunger so that for example even with a relatively sluggish electric motor it becomes possible to achieve the plunger speed required for dispensing the liquid volume in a contact-free manner.

A suitable motor-drive is in particular an electric motor such as a stepper motor or a servo motor. However, other drives as for example a hydraulic or pneumatic motor may also be suitable. Of whatever nature the motor-drive is, it is important that the volume to be dispensed can be metered exactly and that, during the discharge of the air volume, the motor drive is able to accelerate the syringe plunger in a manner such that the syringe plunger has a sufficiently high speed when the liquid volume is to be dispensed. During the dispensing of the liquid volume, the syringe plunger is to be braked to a standstill very quickly. This braking may be effected by the motor-drive. Advantageously an additional brake (e.g. a disk brake) is provided, which additionally or alone brakes the syringe plunger and/or the motor-drive.

The method according to the invention has the advantages that an inexpensive electric motor can be used for driving the syringe, and that a single electric motor can be used for driving a highly parallelized arrangement of for example 96 or 384 syringes which are operated in parallel. The method according to the invention has the further advantage that no additional device such as an impulse generator is required in order to effect a suitable acceleration of the liquid.

In order to keep the friction resistance of the syringe as low as possible and still have good sealing, it is advantageous to not attach the sealing element on the moving syringe plunger but on the stationary pipette cylinder. An annular sealing element being mounted in the pipette cylinder in a stationary manner acts as seal between the pipette cylinder and the syringe plunger. The sealing ring is thus stationary and the plunger acts as displacer. The syringe plunger slides with a low resistance over the sealing element so that the syringe plunger can be displaced in an easy-running manner. Furthermore, there in no need for the bore of the pipette cylinder to have a precise form, which means that an inexpensive pipette cylinder can be used. Since only the annular sealing element is worn, the syringe can be operated for a long time and in an inexpensive manner.

### DESCRIPTION OF THE DRAWING

The method according to the invention as well as the device according to the invention are hereinafter described in detail by way of several exemplary embodiments in connection with a drawing in several figures, wherein:

FIG. 1 is a schematic representation of a pipetting device;

FIG. 2 shows a tip filled with liquid;

FIG. 3 shows a tip which is partly filled with air;

FIG. 4 shows a tip from which the liquid volume VF is dispensed;

FIG. 5 is a speed/time diagram for the plunger of the plunger pipette;

FIG. 6 is a longitudinal section through a plunger pipette;

FIG. 7 shows a tip with an air bubble between the system liquid and the liquid to be dispensed (sample).

### DETAILED DESCRIPTION

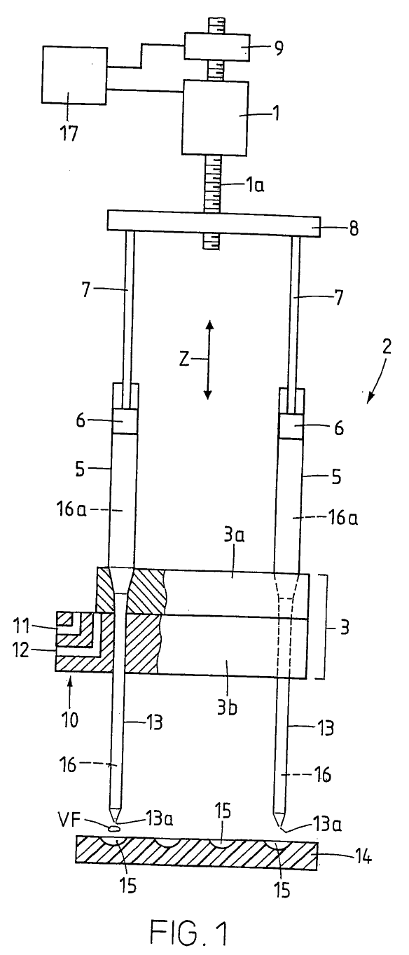

FIG. 1 schematically shows a highly parallelized arrangement of for example 96 or 384 metering pumps 2 being arranged in parallel. The metering pumps are designed as syringes 2, wherein only two of these syringes 2 are shown. The arrangement according to the invention could however also comprise only a single syringe 2. Each syringe 2 comprises a pipette cylinder 5 and a syringe plunger 6 being mounted therein and being moveable in moving directions Z. All syringe plungers 6 are connected to a bar 8 via plunger rods 7. The bar 8 is connected to the electric motor 1 via a spindle 1a. The syringe plungers 6 are thus displaced to and fro in the moving directions Z by the electric motor 1. The pipette cylinders 5 are mounted in a carrier plate 3a. The carrier plate 3a together with a valve plate 3b forms a valve 3. The valve plate 3b which is displaceable horizontally comprises a channel system 10 with channels 11 and 12. Furthermore, tips 13 with nozzle openings 13a are arranged in the valve plate 3b. The tips 13 are positioned above a plate 14 with cavities 15. The syringe system must capable of being completely filled with a liquid 16a, for example with water, without any inclusions of air. This is accomplished by the three-way valve 3, which connects the syringes with reagent supply channels 11 or removal channels 12, the valve being arranged between the syringe 2 and the tip 13.

Furthermore, it may be advantageous to arrange a brake 9 on the spindle 1a or on the motor 1 in order to bring the rotating motor 1 to a standstill as quickly as possible.

The device shown in FIG. 1 is operated as follows.

In a first step, the syringe system is filled completely with a liquid 16a, e.g. with a system liquid such as water. The syringe system is filled in a manner such that no inclusions of air are present.

In a second step, the sample liquid 16 (liquid to be dispensed) is drawn into the pipette tip 13 by way of aspiration from a supply container so that the tip 13 is at least partly filled with the liquid to be dispensed.

In a third step, an air volume VL is drawn into the tip 13 via the nozzle opening 13a of the tip 13.

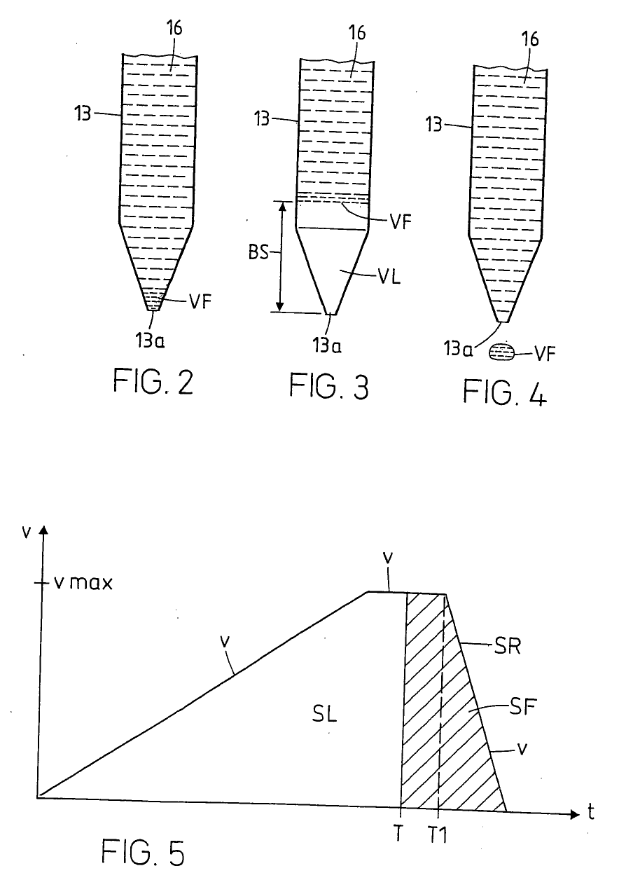

In a fourth step, a predetermined volume of the liquid to be dispensed is dispensed in a contact-free manner by moving and accelerating the syringe plunger 6 downwards (opposite to direction for aspiration), such displacing a volume which is equal to the drawn-in air volume VL and the predetermined liquid volume to be dispensed. Thereafter, the syringe plunger 6 is stopped, and the tip 13 (as shown in FIG. 2), is again completely filled with the liquid 16.

After the above described preparation (first and second step) a plurality of further predetermined liquid volumes VF can be dispensed via the syringe 2 in a contact-free manner by repeating the third and fourth step. FIG. 2 is a schematic longitudinal section through a tip 13 filled with liquid 16, wherein the liquid volume VF to be dispensed is shown in the region of the nozzle opening 13a. This liquid volume VF forms part of the liquid 16 and in FIG. 2 is shown with a different hatching only for simplifying understanding. In the following step (as shown in FIG. 3), the air or gas volume VL is drawn up into the tip 13. The gas volume VL is advantageously a multiple of the liquid volume VF to be dispensed, e.g. ten times the volume VF. For example, for a volume VF of 50 nl of the liquid to be dispensed, the gas or air volume VL may be 500 nl. Thereafter, the syringe plunger 6 is moved downwards with a large acceleration by the electric motor, wherein the syringe plunger 6 up to its standstill is to displace a volume corresponding to the sum of the air volume VL and the liquid volume VF to be dispensed, so that, as is represented in FIG. 4, the liquid volume VF to be dispensed is pressed out of the tip 13. The diameter of the nozzle opening 13a as well as the exit speed of the liquid are selected such that adhesion forces are overcome and the liquid volume VF which for example has a volume in the region between 10 nl and 1 μl is released from the tip 13. The procedure represented in the FIGS. 2, 3 and 4 may be repeated successively several times, wherein the dispensed liquid volumes VF may be of the same size or wherein the dispensed liquid volume VF may be varied by varying the stroke of the syringe plunger 6.

The nozzle opening 13a has for example a diameter of 0.2 mm, and in particular a diameter between 0.1 mm and 0.3 mm. The exit speed of the liquid from the nozzle opening 13a is for example in the region between 2 and 20 m/s and in particular 5 m/s. The air volume VL is for example 950 nl, and the liquid volume VF to be dispensed for example 50 nl. The electric stepper motor 1 is controlled such that the syringe plunger 6 is displaced upwards in 950 steps of the stepper motor and then downwards in 1000 steps. During the downward movement, the plunger is firstly accelerated and then braked. The resulting acceleration path BS in the tip 13 is shown in FIG. 5.

FIG. 5 schematically and by way of example shows a speed-time diagram of the speed v of the syringe plunger 6 moved downwards in the movement direction Z (FIG. 1). During this movement, firstly the air volume VL and subsequently the liquid volume VF to be dispensed is discharged via the nozzle opening 13a. The syringe plunger 6 is accelerated during the discharge of the air volume VL to a speed vmax, and retains this speed until the movement of the syringe plunger 6 is braked. During the dispensing of the air volume VL the syringe plunger 6 covers the distance SL, and during the dispensing of the liquid volume VF it covers the distance SF which is shown hatched. Depending on the size of the air volume VL and of the liquid volume VF to be dispensed, dispensing of the liquid volume VF already begins during the movement at a constant speed vmax, for example at the point in time T, or for example not until the point in time T1 at which the braking procedure begins. Preferably dispensing of the liquid volume VF begins before the point in time T1 and lasts, as shown in FIG. 5 with the hatched area, from the point in time T to the standstill of the syringe plunger 6. Since the liquid is incompressible, during dispensing in such a way, the exit speed of a liquid element located in the exit opening 13a is about proportional to the speed of the syringe plunger 6, or acceleration of the liquid element is proportional to the acceleration of the syringe plunger 6. If the syringe plunger 6 for example has an inner diameter of 2 mm and the exit opening 13a an inner diameter of 0.2 mm, then the speed of the liquid element at the exit opening 13 is about 100 times larger than the speed of the syringe plunger 6.

In order to be able to achieve an as large as possible negative acceleration during the braking of the syringe plunger 6, the stop ramp SR must be suitably steep. Should the electric motor 1 not be able to produce an adequately steep stop ramp SR, the steepness may be increased by an additionally acting brake 9. In the exemplary embodiment of FIG. 5 the stop ramp SR represents such a negative acceleration that the liquid element located in the exit opening 13a experiences a negative acceleration of about 100 m/sec².

It is also evident from FIG. 5 that the air volume VL is required to have such a size that the syringe plunger 6 is able to reach the maximum speed vmax. If the air volume VL is selected too small, the syringe plunger 6 must already be braked before it has reached the maximum speed vmax. The maximum speed vmax is preferably matched to the cross section of the exit opening 13a, to the liquid volume VF to be dispensed, and in particular also to the viscosity of the liquid to be dispensed. The size of the exit opening 13a is preferably selected to be adapted to the size of the liquid volume VF to be dispensed, wherein the geometry as well as the surface nature of the exit opening 13a are to be taken into account. The smaller the liquid volume VF to be dispensed, the more careful the named parameters need to be selected. The smaller the liquid volume VF to be dispensed is, the steeper the stop ramp SR should be in order to ensure a secure, contact-free dispensing of the liquid volume VF. The negative acceleration of the stop ramp preferably lies in such a range that a negative acceleration between 50 m/sec² and 200 m/sec² acts on the liquid element located in the exit opening 13a.

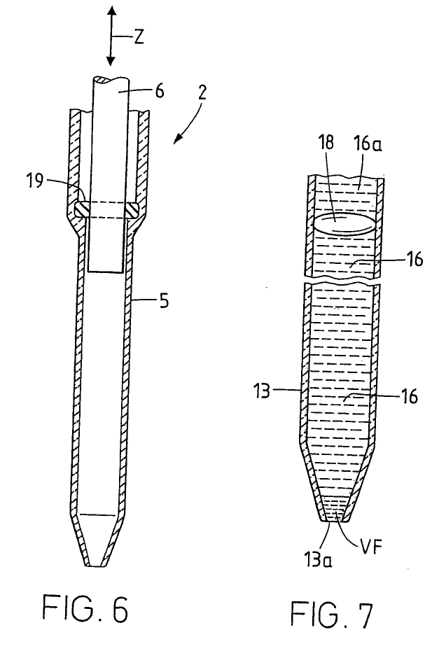

FIG. 6 shows a longitudinal section through an easy-running plunger pipette 2. A sealing ring 19 is rigidly connected to the pipette cylinder 5. The syringe plunger 6 is mounted to be moveable in the moving directions Z and to displace a volume within the pipette cylinder 5.

FIG. 7 shows a longitudinal section through a tip 13, in which liquid is located with an air bubble 18 between the sample liquid 16 and the system liquid 16a. This air bubble 18 prevents mixing of the sample liquid 6 with the system liquid 16a. The size of the air bubble 18 is preferably selected in dependence on the cross section of the tip 13. For example, for a liquid volume VF of 100 nl to be dispensed, the air bubble 18 may have a volume of about 1 μl. With very small liquid volumes VF to be dispensed (e.g. 10 nl), preferably a very small air bubble 18 is selected, or the system is filled with liquid in a manner such that no air bubble 18 results between the sample liquid 16 and the system liquid 16a, i.e. completely without inclusions of air or gas.

FIG. 1 further shows a control device 17 for controlling the metering device according to the invention. This control device 17 may be an integral part of the metering device, but may also be designed as an independent device which is connected to an existing metering device. The control device 17 is designed for controlling the drive device 1 of the metering pump 2, such that the metering pump 2, directly before a liquid volume VF is dispensed, aspires a volume of system liquid 16a corresponding to the gas volume VL and for dispensing the volume VF of sample liquid subsequently delivers a liquid volume of system liquid 16a corresponding to the sum of the gas volume VL and the liquid volume VF to be dispensed, so that a liquid volume VF of the sample 16 is dispensed from the tip 13.

1-14. (canceled)

15. A method for dispensing a volume of liquid, the method for use with a metering pump and a pipette having a tip having an exit opening, the method comprising the steps of:
filling the tip with liquid such that at least in the region of its exit opening it contains the liquid to be dispensed;
drawing a gas volume up into the tip via the exit opening;
dispensing via the exit opening, a volume corresponding to the sum of the volume of the liquid to be dispensed, said volume being of a size less than 1 μl, and the gas volume.

16. The method of claim 15, characterized in that the gas volume is a multiple of the volume of the liquid to be dispensed.

17. The method of claim 15, characterized in that metering is repeated several times, wherein identical or different liquid volumes are dispensed successively.

18. The method of claim 15, characterized in that the pipette comprises a pipette cylinder and a syringe plunger moveably mounted therein, and further characterized in that, for dispensing the volume of the liquid, the syringe plunger is moved in a manner such that it displaces a volume corresponding to the sum of the volume of the liquid to be dispensed and the gas volume.

19. The method of claim 18, characterized in that, during the volume displacement, the syringe plunger is firstly accelerated to a maximum speed and then, during the dispensing of the volume of the liquid to be dispensed, is braked to a standstill.

20. The method of claim 19, characterized in that a liquid element located in the exit opening is braked with a negative acceleration of at least 50 m/sec².

21. The method of claim 20 in which the negative acceleration is about 100 m/sec².

22. The method of claim 15, characterized in that the liquid volume is dispensed via the exit opening with a throughput speed of at least 3 m/s.

23. The method of claim 15, characterized in that the liquid volume to be dispensed has a size in the region between 10 nl and 1 μl and is dispensed in a contact-free manner.

24. An apparatus comprising:
a metering pump;
a pipette;
the pipette having a tip connected thereto in a liquid-conducting manner;
the tip comprising an exit opening for dispensing the liquid volume;
a drive device for driving the metering pump, characterized in that the metering pump is able to be driven in a manner such that a suctioning is effected at the exit opening directly before dispensing the liquid volume, and thereafter a dispensing is effected, in order to first suction a gas volume via the exit opening, and thereafter to dispense the gas volume as well as a liquid volume via the exit opening;
the liquid volume being of a size of less than 1 μ.

25. The apparatus of claim 24, characterized in that the drive device comprises an electric motor.

26. The apparatus of claim 24, characterized in that a valve is arranged between the metering pump and the tip, the valve being designed in a manner such that the liquid-conducting connection between the metering pump and the tip is able to be completely filled with liquid.

27. The apparatus of claim 24, characterized in that the tip comprises an exit opening with a diameter between 0.1 mm and 0.3 mm.

28. The apparatus of claim 27 wherein the exit opening diameter is about 0.2 mm.

29. The apparatus of claim 24, characterized in that the pipette comprises a pipette cylinder with an annular sealing element being mounted in a stationary manner therein and being designed as a seal between the pipette cylinder and a syringe plunger being movably arranged in the pipette cylinder.

30. The apparatus of claim 24, further comprising a control device, the control device characterized in that the control device is designed for controlling the drive device of the metering pump in a manner such, that the metering pump, directly before dispensing the volume of liquid to be dispensed, displaces a liquid volume corresponding to the gas volume away from the tip, and thereafter displaces a liquid volume corresponding to the sum of the gas volume and the volume of the liquid to be displaced towards the tip.
